(19) United States
(12) Patent Application Publication
(10) Pub. No.: US 2004/0030783 A1
(43) Pub. Date: Feb. 12, 2004

(54) Method for serving audio and image communication in web browser using session initiation protocol

(76) Inventor: Jae-Won Hwang, Seoul (KR)

Correspondence Address: Robert E. Bushnell, 1522 K Street, N.W., Suite 300, Washington, DC, 20005, US

(21) Appl. No.: 10/214,094

(22) Filed: Aug. 8, 2002

(51) Int. Cl. G06F 15/16

(52) U.S. Cl. 709/227

(57) ABSTRACT

The present invention relates to a method for voice and image communication in a web browser by installing SIP (Session Initiation Protocol), part of VoIP (Voice over Internet Protocol) technology that transceives voice over the Internet, into the web browser. According to the present invention, using the web browser including a first module for taking a number of procedures to make a call with another party the SIP wants, a second module for taking a procedure for processing an incoming call, and a configuration that connects a call to a party whom SIP proxy server wants by inquiring position of the party based on information that is provided from the second module, data at a corresponding site is transferred in order of HTTP (Hyper Text Transfer Protocol) communication access order, and the transferred data is used for the voice and image communication according to a protocol supported from a linked SIP by clicking the SIP displayed on a screen by HTML.

### BACKGROUND OF THE INVENTION

1. Field of the Invention

The present invention relates generally to an audio and image communication method in a web browser, and more particularly, to a method for serving an audio and image communication in a web browser, which enable both the audio and the image communication on a web browser by embedding SIP (Session Initiation Protocol), part of VoIP (Voice over Internet Protocol) technology that transceives voice over the Internet in the web browser.

2. Description of the Related Art

Recently, the Internet has been developed as a global computer network. In fact, the Internet is a global network where most computer networks from businesses and colleges over the world are interconnected to one another via wide area circuit. Through a computer device, a user can get every kind of Internet service. For example, the computer device provides services like e-mail, through which a user can send a message to a particular receiver, remote computer access for using a remote computer device, file transfer protocol for transferring resources, and “WWW” (world wide web), a hyper link structured multimedia information provider, in which net news and pages for providing information and discussing different kinds of themes are mutually linked together. Especially, in the WWW, data is transferred in order of communication access order called HTTP (Hyper Text Transfer Protocol), and home pages are displayed on a screen through recorded files in HTML (hypertext markup language), and the information is eventually searched and read on the screed. The user, using a WWW browser, can access to the WWW server, and receives information and services provided, while the information provider provides information and gets service from the WWW browser using the WWW browser. When the user requests hyper linked information using the WWW browser, he or she first specifies a home page address to access, which causes a client computer device to make a request of the WWW server having the home page for information transfer. Receiving the request, the WWW server transfers the HTML file of the specified home page. The client computer device analyzes the HTML file and displays any displayable parts on the display. If the HTML file includes other data (for example, image information) inside, another transfer request is made an issue. In addition, when the information displayed by the client computer device includes any related information, the information is recorded below for indication. When the user clicks the information, the client computer device sends his or her transmission request to the WWW server having that particular information, and eventually, the WWW server receiving the information request transfers a designated HTML file of a new page. The linked file information in this way is continuously provided to the user as he or she repeats the manual clocking operation on the continuous method. Although this kind of method has been available for a particular site for data service only, more people are now favoring the VoIP (Voice over Internet Protocol), one of voice transfer technologies using the Internet. Unfortunately though, the VoIP technology is not appropriate for the Internet in that its protocol is too vast and tightly framed. Further, when a telephone line is used for the voice transfer, although it could provide good voice quality and stable call status, it is very expensive and cannot provide multimedia service as Internet does.

This application makes reference to, incorporates the same herein, from my application entitled METHOD FOR SERVING AUDIO AND IMAGE COMMUNICATION IN WEB BROWSER USING SESSION INITIATION PROTOCOL filed with the Korean Industrial Property Office on 21 Feb. 2001 and there duly assigned Ser. No. 2001-8791.

### SUMMARY OF THE INVENTION

It is, therefore, an object of the present invention to provide a method for audio and image communication in a web browser by mounting SIP (Session Initiation Protocol) on the web browser to get several times better service effect.

It is another object to provide a technique for audio and image communication in a web browser mounted with the SIP having the data and voice integration service that can accelerate voice and image communication over the Internet.

It is yet another object to provide a technique for audio and image communication in a web browser having the SIP that enables much more multimedia communication through a network terminal, such as, desktop PC (personal computer), note PC, PDA (personal digital assistant) or cellular phone.

To achieve the above and other objects, there is provided a method for serving voice and image communication on a web browser using SIP (Session Initiation Protocol), the web browser including a first module for taking a number of procedures to make a call with another party the SIP wants, a second module for taking a procedure for processing an incoming call, the method including the steps of: connecting a call to a party whom SIP proxy server wants by inquiring position of the party based on information that is provided from the second module; transferring data at a corresponding site in order of HTTP (Hyper Text Transfer Protocol) communication access order; and performing the voice and image communication by using the transferred data according to a protocol supported from a linked SIP by clicking the SIP displayed on a screen by HTML (Hyper Text Markup Language).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a system diagram for explaining an embodiment of the present invention;

FIG. 2 is a SIP (Session Initiation Protocol) diagram in accordance with the embodiment of the present invention; and

FIG. 3 is a flow chart of SIP in accordance with the embodiment of the present invention.

### DETAILED DESCRIPTION OF THE PREFERRED EMBODIMENTS

A preferred embodiment of the present invention will be described herein below with reference to the accompanying drawings. In the following description, well-known functions or constructions are not described in detail since they would obscure the invention in unnecessary detail.

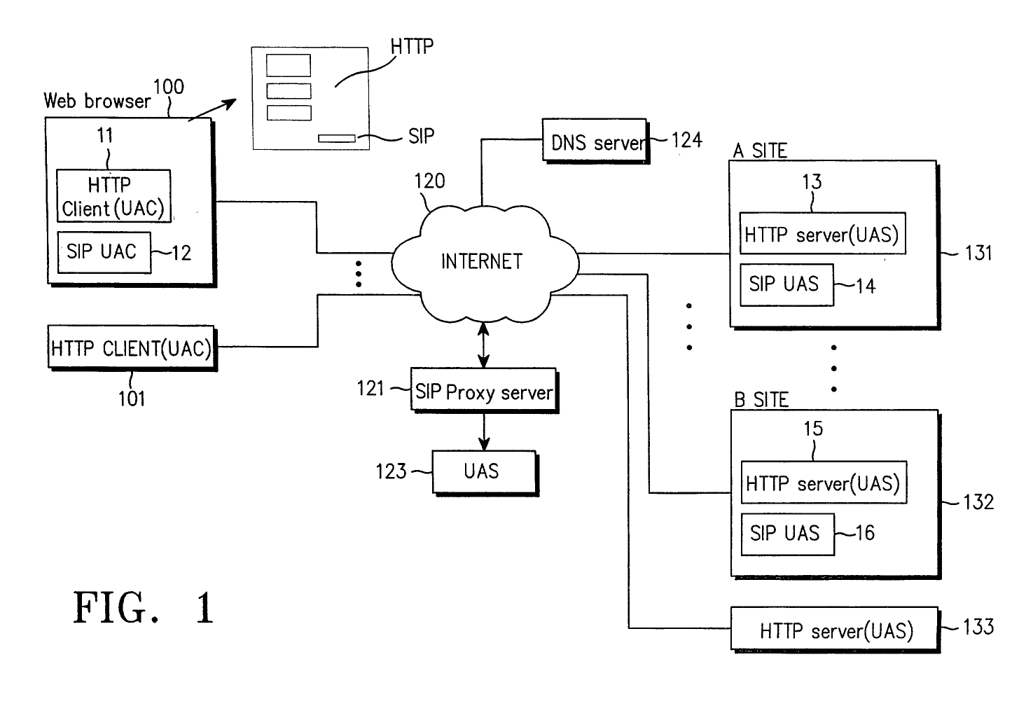

FIG. 1 is a system diagram in accordance with the present invention.

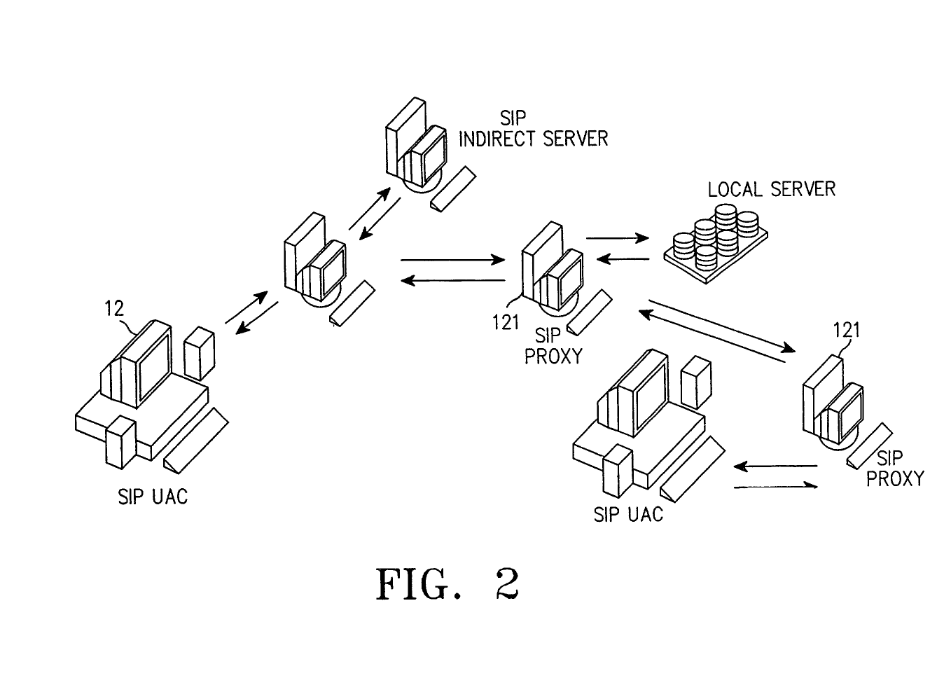

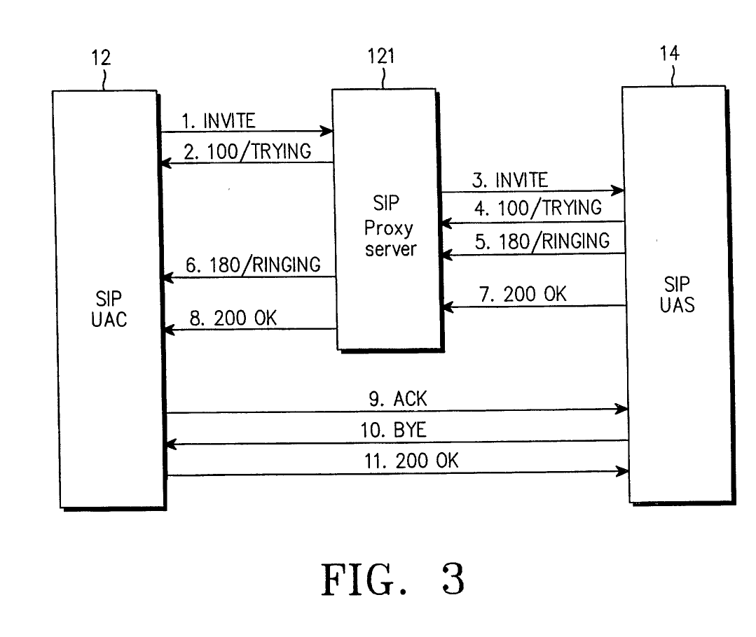

There are several kinds of methods for adding voice communication function to the web browsers 100 and 101. One of them is to use SIP (Session Initiation Protocol) because the SIP has a very simple configuration and is modularized so, compared to others, SIP has high portability and flexibility. More specifically, the SIP is a standard protocol designated by IETF (Internet Engineering Task Force) for voice transfer over the Internet. Although it has not been commercialized yet, it will be soon generalized. Further details on the SIP are found in PCT/No99/00353 as WO 00/33550 for METHOD FOR EXTENDING THE USE OF SIP (SESSION INITIATION PROTOCOL) by Corneliussen et al., so more specified explanation about the SIP would not be provided here. The present invention may include the web browser 100 having HTTP client (UAC: User Agent Client) with SIP UAC 12 or the web browser 101 having HTTP client (UAC) without the SIP UAC 12. SIP UAC 12 is installed in the web browser 100 because the configuration of the SIP itself takes e-mail display format, and has the HTTP protocol as a main body, meaning that it couples with the web browser very well. In addition, the SIP UAS 14 and 16 are added on the HTTP server (UAS: User Agent Server) 13 and 15 in each site, “A” site 131 and “B” site 132 among other sites 131, 132, and 133 that provide information through the Internet 120, and the sites A and B includes SIP proxy server 121. In other words, the SIP, as shown in FIG. 2, includes UAC (User Agent Client) 12, UAS (User Agent Server) 14, and SIP proxy server 121, and they are operated in the order described in FIG. 3. Here, SIP UAC 12 and SIP UAS 14 are essential modules to the web browser. The SIP UAC 12 is a module for performing a plurality of procedures to make a call to another party. The SIP UAS 14 is a module for taking procedures to process an incoming call. Lastly, the SIP proxy server 121 is a server that connects a call to another party by inquiring position of the party based on the information which is sent from the SIP UAC 12.

With reference to FIGS. 1, 2 and 3, the embodiment of the present invention is further expounded.

By installing SIP UAC 12 and SIP UAS 14 modules into the web browser, a direct voice communication with the other party becomes possible as illustrated in FIG. 3. The procedure thereof is very much similar to the one found in the personal computer in general. That is, the user connects to the HTTP server 13 of A site in order of HTTP protocol access at the HTTP client 11 of the web browser 100, searches information he or she wants, transfers the information found, displays the file recorded in HTML on a screen for data read. At this time, if there is an indication for the SIP, the user clicks a corresponding item, just as in the computer where a user accesses to a corresponding site by clicking a mouse (Hyper text). Other functions can be added here. In other words, even when a receiver is not present, it is possible to leave a voice message, send an e-mail, or connect to a cellular phone. Moreover, the SIP comes in handy for home shopping as well. When the SIP link is placed next to a product, the user can get into conversation right away and purchase things, and if the network allows, he or she can even see the face while making a purchase.

In conclusion, thanks to the web browser mounted with the SIP, the data and voice integration service can accelerate voice and image communication over the Internet. Moreover, the web browser having the SIP enables much more multimedia communication through network terminal, such as, desktop PC, note PC, PDA or cellular phone.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for serving voice and image communication on a web browser using Session Initiation Protocol, the web browser including a first module for taking a number of procedures to make a call with another party the Session Initiation Protocol wants, a second module for taking a procedure for processing an incoming call, the method comprising the steps of:
connecting a call to a party whom a Session Initiation Protocol proxy server wants by inquiring position of the party based on information provided from said second module;
transferring data at a corresponding site in order of Hyper Text Transfer Protocol communication access order; and
performing the voice and image communication by using the transferred data according to a protocol supported from a linked Session Initiation Protocol by clicking the Session Initiation Protocol displayed on a screen by Hyper Text Markup Language.

2. The method of claim 1, said first module comprising a Session Initiation Protocol user agent client.

3. The method of claim 1, said second module comprising a Session Initiation Protocol user agent server.

4. An apparatus, comprising:
a first unit including a first module taking a number of procedures to make a call with another party a Session Initiation Protocol wants;
a second unit including a second module for taking a procedure for processing an incoming call, said second unit connected to said first unit through a network;
a proxy server using a Session Initiation Protocol, connecting a call to a party whom said proxy server wants by inquiring position of the party based on information provided from said second module, said proxy server being connected to said first and second unit through the network, said first module, said second module and said proxy server accommodating of transferring of data at a corresponding site in order of Hyper Text Transfer Protocol communication access order, performing voice and image communication by using the transferred data according to a protocol supported from a linked Session Initiation Protocol by actuating the Session Initiation Protocol displayed on a screen on said first unit by Hyper Text Markup Language.

5. The apparatus of claim 4, said first module comprising a Session Initiation Protocol user agent client.

6. The apparatus of claim 4, said second module comprising a Session Initiation Protocol user agent server.

7. The apparatus of claim 5, said second module comprising a Session Initiation Protocol user agent server.

8. The apparatus of claim 4, said first unit being a member of a group consisting of desktop personal computer, laptop personal computer, personal digital assistant, and a cellular phone.

9. A method, comprising the steps of:
connecting a call to a party whom a Session Initiation Protocol proxy server wants by inquiring position of the party based on information provided from a second module, a first module for taking a number of procedures to make a call with another party the Session Initiation Protocol wants, said second module for taking a procedure for processing an incoming call said second module;
transferring data at a corresponding site in order of Hyper Text Transfer Protocol communication access order; and
performing the voice and image communication by using the transferred data according to a protocol supported from a linked Session Initiation Protocol by actuating the Session Initiation Protocol displayed by Hyper Text Markup Language.

10. The method of claim 9, further comprising of installing said first module in a web browser before connecting the call to the party.

11. The method of claim 9, further comprising of installing said second module in a first web site on a Hyper Text Transfer Protocol server.

12. The method of claim 10, further comprising of installing said second module in a first web site on a Hyper Text Transfer Protocol server before connecting the call to the party.

13. A method for serving voice and image communication on a web browser using Session Initiation Protocol, the web browser including a first module for taking a number of procedures to make a call with another party the Session Initiation Protocol wants, a second module for taking a procedure for processing an incoming call, the method comprising the steps of:
connecting a call to a party that is desired by inquiring position of the party based on information provided from said second module;
transferring data at a corresponding site in order of Hyper Text Transfer Protocol communication access order; and
performing the voice and image communication by using the transferred data according to a protocol supported from a linked Session Initiation Protocol by actuating the Session Initiation Protocol displayed by Hyper Text Markup Language.

14. The method of claim 13, further comprising of installing said first module on said web browser and said second module being on a Hyper Text Transfer Protocol server.
